(19) United States
(12) Patent Application Publication
(10) Pub. No.: US 2009/0106153 A1
(43) Pub. Date: Apr. 23, 2009

(54) SECURING CARD TRANSACTIONS

(76) Inventor: Meir Ezra, Clearwater, FL (US)

Correspondence Address: YORAM TSIVION, P.O. BOX 1307, PARDES HANNA, 37111, IL

(21) Appl. No.: 12/299,614

(22) PCT Filed: May 2, 2007
(86) PCT No.: PCT/IL2007/000535

§ 371 Date: Nov. 5, 2008

Related U.S. Application Data
(60) Provisional application No. 60/746,172, filed on May 2, 2006.
(60) Provisional application No. 60/892,621, filed on Mar. 2, 2007.

(51) Int. Cl. G06Q 40/00

(52) U.S. Cl. 705/44

(57) ABSTRACT

A system for approving transaction card transactions in which a card reader associated with a transaction approving authority (TAA). A source for complementary security data is linkable to the TAA can send data to the TAA, and a database linkable to the TAA keeps renewable security data of a user. A database linkable to the TAA keeps records of geographical locations of subscribed businesses. The system of the invention is applicable as a countermeasure against identity theft.

### FIELD OF THE INVENTION

The present invention is in the field of fund transactions security such as to the security of credit card transactions, or that of any other method of electronic payment transactions (such as cell, smart cards, internet etc).

### BACKGROUND OF THE INVENTION

Electronic and transactions, especially those made with a credit card, are subject to the threat of fraudulent activities. The unauthorized use of a credit card (CC) is a cause for concern for consumers especially if the amount of funds stolen cannot be recovered. In a co-pending U.S. patent application Ser. no. 10/871,421 by the same inventor, the contents of which are incorporated herein by reference, a system for enhancing the security of fund transactions that use a personal card such as a CC is disclosed. In that invention, an additional active information source is employed by the user of the card, such that cross referencing of the two personal sources is required to authorize the transaction. The cross referencing may be implemented as a private key—public key combination to encrypt/decrypt the personal security number sent to the transaction approving authority (TAA). If a personal security number sent is unencrypted, it may be considered insecure. The present invention broadens the former invention aiming at increasing the security of transactions made using transaction cards, as will be explained in the description below.

Identity theft (or impersonation fraud), is the co-option of another person's personal information (e.g., name, Social Security number, credit card number, passport) without that person's knowledge and the fraudulent use of such knowledge. There are numerous ways in which identities can be stolen, some are described herein. Fraudsters retrieve documents such as bank statements, utility bills or even junk mail that a person has thrown away. Cloning of payment cards is done using devices bolted onto cash machines, or by being copied by unscrupulous individuals with access to the credit/debit card, for example, staff in restaurants or petrol stations. The victim information obtained can be used to apply for opening new credit cards in the same name, making charges, and leaving the bills unpaid. The fraudsters have also been known to make transactions on the victim's original credit cards.

### BRIEF DESCRIPTION OF THE DRAWINGS

FIG. 1 is a schematic description of the succession of steps performed in accordance with one aspect of the invention to approve of a credit card transaction;

FIG. 2 is a schematic description of the succession of steps performed in accordance with a second aspect of the invention to approve of a credit card transaction;

FIG. 3A is a schematic description of the main components of the system in which the invention is implemented;

FIG. 3B is a schematic description of the main components of the system including one card reader;

FIG. 4 is a schematic presentation of the connections between components of the system of the invention relating to site location.

### DETAILED DESCRIPTION OF THE PRESENT INVENTION

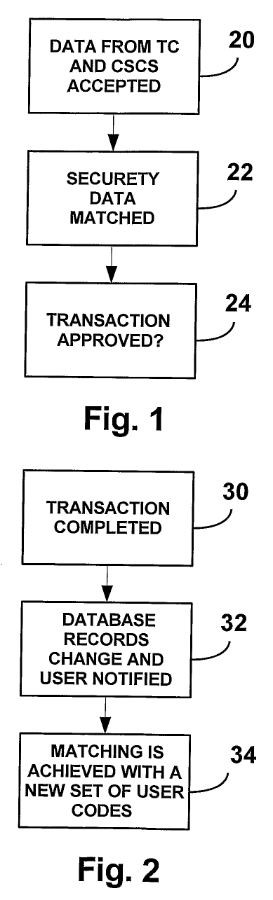

In accordance with the present invention, a transaction card (TC) holder sends a complementary security piece of data (CSD) that may or may not be physically associated with the TC and which is typically a number. Therefore, in any single transaction, the buyer (user) sends at least two distinct pieces of security data. One source of security data is the TC itself which contains data in a magnetic strip attached to the card, or in an electronic circuit on the card or is entered from a keypad or from any other electronic source. The CSD is sent to at least one clearing house or to at least one a transaction approving authority (TAA). In accordance with the present invention, the number of CSDs is not limited, so that the number of security data sent is 1+ the number of CSDs employed. The complementary and TC security data is typically an encrypted number. To approve a transaction, the TAA matches the pieces of data received from each source of CSD and the transaction card. Schematically, this is described in FIG. 1. The TAA accepts security data from one or more TCs and one or more CSD sources respectively, each by the same or a different link, in step 20. The TAA then matches the pieces of received security data, based on database records, in step 22. Then, in step 24 the transaction is approved, if a match has been achieved.

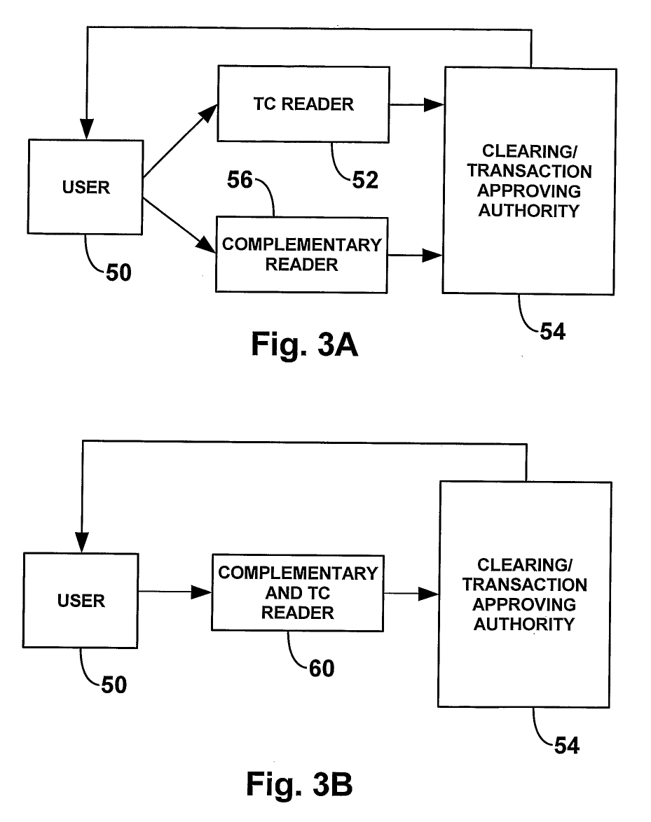

According to an additional aspect of the invention, after a transaction has been accomplished, the TAA or the clearing house that transfers the funds issue a new complementary security data (typically a new number) that must be received by the user. When the user confirms receipt of the new security number, the database is changed such that records relating to the security data of the specific user are changed to conform with the data sent to the user. An example of this aspect is schematically described with reference to FIG. 2. A transaction involving a TC is completed in step 30. Then the database records the change in step 32, so that matching based on the database records can be achieved in step 34 only as new user codes is obtained from the user. The main components of a payment system implementing the method of the invention are described schematically by way of example in FIG. 3A to which reference is now made. User 50, a buyer, sends a piece of security data, typically a number, existing on his/her transaction card (TC). The data can be sent by entering the number to a secured web page or by any other electronic form such as card reader. This card may be an electronic wallet, payment card or more frequently a credit card. Referring to FIG. 3A, the security data from the card is read by card reader 52, which transfers the data to the clearing house or to a third party transaction approving authority (TAA) 54. The transaction approving authority receives from reader 56 security data relating to the transaction, and which is different than the TC data. The two (or more) pieces of data are matched by TAA 54. When the transaction has been approved and completed, TAA 54 (or the clearing house) send a new data to be used as complementary data in the next transaction. This data is sent by one of several ways and is stored in the users' memory. As the case may be, a renewal of complementary security data may be effected every new transaction or less frequently, such as every two or three transactions. Moreover, the user may decide to shut off the complementary security mechanism altogether if granted such authority, and restart it accessing the service from a terminal such as a personal computer, telephone or any other ways of communicating instructions.

The main components of a payment system including a one card reader are described schematically in FIG. 3B to which reference is now made. User 50, sends a piece of security data, typically a number, existing on his/her transaction card (TC). The security data from the card is read by card reader 60, which transfers the data to the clearing house or to a third party transaction approving authority (TM) 54. The transaction approving authority receives also from reader 60 security data relating to the transaction, and which is different than the TC data. The two (or more) pieces of data are matched by TM 54. When the transaction has been approved and completed, TM 54 (or the clearing house) sends new data to be used as complementary data in the next transaction.

The card reader can implement a long or short range reading mechanism and may or may not include an access mechanism. For example, if a cell phone is used as a card reader it may be able to read and write to the card only once a user entered a code or the card may have an off/on button and only at the time of the transaction a short burst transmission is allowed to send and receive the new complementary security data.

Sending and Receiving Security Data

The updating of the security data is implemented online or offline. An online implementation requires that there be active communications between the user and the service provider. A variety of communication systems may be used for sending the security data and accepting the new data from the TM. For example cellular telephony, SMS, internet, regular phone system, interactive TV. Typically the user may commence the service by calling a service provider that maintains a computer for generating the new numbers and updates the database in order that the new transaction is authorized by the TAA. In a preferred embodiment of the invention the user holds an active device, a transceiver that can communicate with the TAA, sending complementary security data and receiving updated security data. In an offline implementation, only a limited number of possibilities of security data changes is provided and when a new connection is made, a synchronization is made and new security data is generated with the service provider.

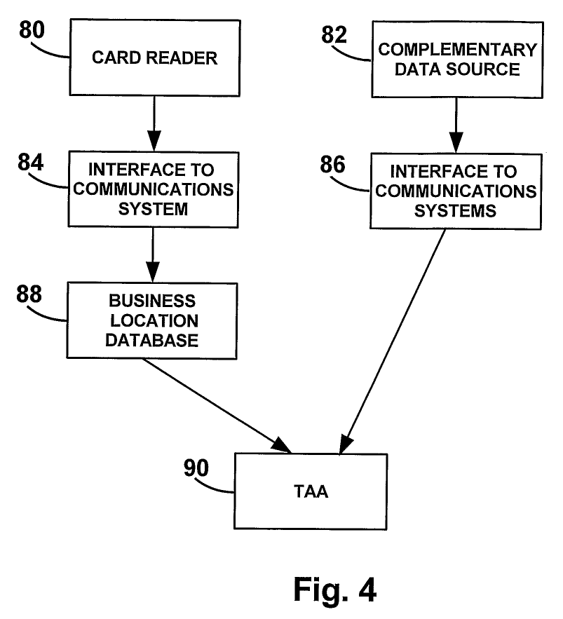

In accordance with another aspect of the invention, authorization of a transaction is accomplished if both pieces of security data sent from the transaction card (TC) and the complementary data emanate from the same geographical location. In other words, for a full match for authorization of a transaction to be made, two conditions must be met, namely, the separate pieces of security data such as the new complementary security data sent from TAA after a transaction confirmation is required, and a location identity between the TC and the source of the complementary security data is confirmed. However, even if the system is fully enabled for double security, a policy decision may be made to downgrade the double security routes to only one such route, To establish the information regarding the location, typically electronic communications systems are used. For example, while the TC is read by a TC reader in a shop, a call to the transaction approving authority (TAA) is made. This call is implemented using a physical telephone line, and the TAA receiving the call can further match the calling number with a subscribed business, having a definite business location recorded in the appropriate database. The complementary security data on the other hand, can be sent using a regular cellular telephone call. The cellular system is basically location sensitive, not only with regards to the identity of the base station connected but also with regards to the distance from the base station. The cellular telephone system can provide some information regarding the location of the mobile set. Other communications services offer various degrees of location accuracy. In general, a high degree of location accuracy is obtained by navigation means, typically satellite navigation systems. LBS (location based services) are gaining wide acceptance and many more technological advancements in this area of service providing are likely to spring up. An example of an embodiment of the invention implementing location determination is further explained with reference to the block diagram of FIG. 4. Data is obtained from credit card reader 80 as well as complementary security data source 82 through respective communication interfaces 84 and 86. The two respective security data pieces are searched by the TAA. The source of data containing the card code is verified base on the business location database 88. In contrast, the source of complementary data is obtained from or at least through the communications system, and interfaced through interface 86. TAA 90 thus accepts information regarding the location of the card and the source of the complementary security data, and performs a double search in the linked databases for matching both aspects. If both pieces of security data are matched and if the distance between the two sources has been determined as sufficiently short, the transaction is approved. If more than one source of complementary security data is used, the TAA has to carry out searches and verification for each of the sources of complementary security data with respect of the TC. In another aspect of the present invention, sources of complementary security data and card readers can be customizable for some or all of the transactions a user makes, for example the degree of security for a transaction can be changed from one user to another or from on shop or firm to another.

Prevention of Transaction Cards Frauds Related to Identity Theft

Implementing the present invention, a fraudster who stole an identity of a fraud victim will be faced with additional impediments in his/her attempts to benefit from the fraud. For example, in a scenario in which the fraudster succeeded in obtaining the victim's identity, and subsequently produced a fake TC, he/she will eventually try to use it for example to make transactions at the expense of the victim. The TAA will receive only fragments of the security data sent from the TC thus, the transaction will not be accepted by TAA because the complementary fragment or fragments of the security data source will still be missing. Moreover, it will be impossible in the long run to remain undetected as sooner or later the true holder of the card will use the card and a mismatch will appear in the system as the security number of the true owner and the security number of the fraudster will be different. In addition it will be very difficult to produce the complementary security data source. Both fragments of the security data are matched and if the difference between what is expected as a fit and what is received by the TAA is larger than acceptable, the transaction will not be approved. For example, in geographical terms, considering the case where the owner of a TC makes a transaction at time T₁ in a store positioned in G₁. Later, a fraudster tries to make a transaction with a fake TC at time T₂ (T₂>T₁) in a store positioned in G₂. An identification of location, G₁ of the applicant for transaction approval is larger than for example twenty kilometers would not allow the TAA to approve of the transaction, for a specific T₂, T1. Another example, if a numeric input of the fragment of data deviates from an expected number, the transaction will not be approved. The system may require exact match with no deviations at all.

However, even if the fraudster is able to duplicate or produce a functional TC using fraudulent identity and accomplish one or more authorized transactions, because less strict demands for security are implemented in such cases, the perpetuation of fraudulent activity will be intercepted and identified as such when he/she are not aware that more strict demands are made. When fraudulent activity is identified, the activation of the TC can be stopped immediately, and even past actions may be searched to identify fraud.

1. A system for approving transaction card transactions comprising:
a card reader associated with a transaction approving authority (TAA);
a source for complementary security data linkable to said TAA;
a database linkable to said TAA for keeping renewable security data of a user, and
a database linkable to said TAA for keeping records of geographical locations of subscribed businesses.

2. A system for approving transaction card transactions as in claim 1 and wherein said source for complementary security data is a transceiver carried by a user of said transaction card.

3. A system for approving transaction card transactions as in claim 1 and wherein said database linkable to said TAA for keeping renewable security data of a user and said database linkable to said TAA and said database linkable to said TAA for keeping records of geographical locations of subscribed businesses are utilized for securing transaction card transactions from frauds related to identity theft.

4. A method for approving a fund transfer transaction by a user using a transaction card, said method comprising:
sending at least two pieces of security data, one from a transaction card reader and at least one piece of complementary security data from at least one source of complementary security data to transaction approving authority;
accepting said at least two pieces of security data;
performing a double search on said accepted pieces of data for both confirming the match between the pieces data, and for confirming a geographical nearness between said transaction card and between said at least one source of complementary security data, and
approving said transaction, and
renewing at least one piece of security data associated with said user in a database associated with said transaction approving authority.

5. A method for approving a fund transfer transaction by a user using a transaction card as in claim 3 and wherein said renewing of said at least one piece security data is performed online.

6. A method for approving a fund transfer transaction by a user using a transaction card as in claim 3 and wherein said renewing of said at least one piece security data is performed offline.
